(19) United States
(12) Patent Application Publication
(10) Pub. No.: US 2010/0070413 A1
(43) Pub. Date: Mar. 18, 2010

(54) SYSTEM FOR THE OPERATIONAL ACTIVATION OF BANKING ATM NETWORKS AND METHOD FOR THE MANAGEMENT OF BANKING ATM EQUIPMENT NETWORK

(75) Inventors: Priscila Teles Da Silva, Sâo Paulo (BR); Heloisa Helena Wermersch, Boaçava (BR); Luciano Fernandes Teixeira, Cotia (BR); Mârio Roberto Porto Filho, Barueri (BR)

Correspondence Address: CANTOR COLBURN, LLP, 20 Church Street, 22nd Floor, Hartford, CT, 06103, US

(73) Assignee: TECNOLOGIA BANCARIA S.A., Barueri (Sao Paulo) (BR)

(21) Appl. No.: 12/499,371

(22) Filed: Jul. 8, 2009

(30) Foreign Application Priority Data
Jul. 11, 2008 (BR) PI 0802535-5

(51) Int. Cl. G06Q 40/00; H04W 4/12

(52) U.S. Cl. 705/43; 455/466

(57) ABSTRACT

The “SYSTEM FOR THE OPERATIONAL ACTIVATION OF BANKING ATM NETWORKS AND METHOD FOR THE MANAGEMENT OF BANKING ATM EQUIPMENT NETWORK” is more particularly related to a system (1) of operational activation of banking ATM networks and a method for the management of banking ATM equipment networks, prominently developed to provide the market with the best levels of quality, knowledge, and availability, moreover, allowing for the aforementioned ATM networks to be managed in a total or partial form, through its pieces of equipment and financing institutions and, besides that, in the segment of modes of payment, the system also becomes responsible for the administration of the capture terminals of the services of Electronic Funds Transfer (EFT) and, in that way, it ensures a tool which allows for greater efficacy in the monitoring and the reduction of the length of time of catering to the operational demands, promoting greater expeditiousness and flexibility in the operational processes, ensuring greater efficacy in the monitoring of the parks of terminals, also reducing the length of activation time of the field task forces.

### TECHNICAL FIELD OF THE INVENTION

The present invention is related to a system of operational activation of banking ATM networks and a method for the management of banking ATM equipment networks, conspicuously developed to provide the market with the best levels of quality, knowledge, and availability allowing, moreover, for the mentioned networks to be managed in a complete or partial form, through its equipment and financing institutions and, besides that, in the segment of payment modes, the system also becomes responsible for the administration of the capture terminals for the services of Electronic Funds Transfer (EFT), and—in that way—ensures a tool that allows for greater efficacy in the monitoring and in the reduction in the length of catering time to operational demands, promoting greater expeditiousness and flexibility in the operational processes, ensuring more efficacy in the monitoring of terminal parks, reducing the length of deployment time of the field teams, as well.

### BRIEF DESCRIPTION OF THE RELATED ART

How is widely known by the public and, specially, by the professionals involved in that specific area of the market, the baking technology is irreversibly implemented in the vast majority of the financing institutions and, when making last generation equipment available, the bank network passes, onto the client, the responsibility to perform the most diverse operations on ATM, such as cash and deposits, withdraws, funds transfer, and payment of bills, thus pleasing many people, in view of the conveniences offered.

The main objectives of the financing institutions with this measure are: reducing operational costs with personnel, and dwindling the lines within the physical branches and, as a consequence, increasing profits.

The utilization of the Internet is also present in an ever growing fashion in the banking midst, enabling the client to perform countless banking operations without leaving home. However, this range of conveniences can not benefit all of the clients indiscriminately.

The focus must be directed to the reduction of costs, the transformation of fixed costs into variable costs, the gains in efficiency and governance, clear definitions of SLAs and greater control, elevation in the service level, striving to focus in the Core Business, in the Management of the ATM Network (integrated and automatic), in the customized solution catering to the needs of the Financial Institutions—Offering of transactions, customization of the solution, independent and modular solutions, independence from the equipment supplier, high expertise, focus in security, optimization of the processes, quality of the service, based on levels of service agreement, reduction in costs through scale gain, technology platform in constant evolution, nation-wide catering range and, still, the possibility of sharing networks.

However, the difficulty and the complexity of the existing systems are very high, and excellence is an objective which feeds the development of the management systems of banking ATM.

### BRIEF SUMMARY OF THE INVENTION

Having all those inconveniences in mind, and interested in promoting improvements in the consumer market, the inventor has developed, after countless investigations, this “SYSTEM FOR THE OPERATIONAL ACTIVATION OF BANKING ATM NETWORKS AND METHOD FOR THE MANAGEMENT OF BANKING ATM EQUIPMENT NETWORK”, which must stand before its peers and stand out before the consumer market by the fact that it presents a system of operational activation of banking ATM networks which foresees a quite efficient monitoring environment for managing networks with greater expeditiousness in the response to the service orders, and which, besides that, enables the company to optimize the deployment of the field task force in the solicitations for technical assistance to the terminals and to elevate the productivity of the team.

This set of procedures and steps to be fulfilled is liable of promoting a centralized management of information, which ensures a better control and management of the networks, management of the operational processes (activations, operational and technical catering), intelligent activation (business rules defined by the system), optimization of the action of the monitoring technical assistants y automating some of the steps of the process, reduction in the volume of interventions of the field task force, increase in the number of remote actions, consolidation of the information in a single system; friendly interface; greater flexibility in the creation and adaptation of the processes of work; facilitating the integration of the systems which support the operational management.

All the procedures which involve this context have been developed using BMC Remedy's ARS (Action Request System) workflow tool, integrated with a marketed mobile communication solution—compatible with the main cellular telephone operating companies. Through this integration, the field task force receives the occurrences of the ATM network via text messages in their very own communication radios.

Besides that, this system is also composed of corporate registers developed make flexible and allow for strategic changes in the business rules pertinent to the activation and operational catering. These registers also provide the workflow with the necessary business intelligence for more than 50% of the occurrences to be activated automatically.

For the management of the regional operations and of the outsourced partner companies in the operational catering, it has been made available a Web interface characteristic of the workflow tool (Mid-Tier) for the follow-up and treatment of the occurrences.

Still, instructions have been developed, which are automatically sent by the workflow to the ATM application through messaging, with the objective of remote treatment of the occurrences. For that purpose, it has been used the methodology for Project Management: PMI/PMBoK, the process for software development: RUP, and the documenting tool of choice had been Word.

In order for all these benefits to be achieved and the final objective to be attained, a differential structure has been developed based on four phases of procedures, such as described in below:

Phase 1—AsTO's availability control;

Phase 2—Optimization of the activation;

Phase 3—Implementation of the chain of activation and implementation of the remote actions; and

Phase 4—Automation of the activation and of the remote actions.

The entire system has been developed using the “ARS (Action Request System) workflow tool” of BMC Remedy, integrated with a “Dispara” mobile communication solution which is compatible with the main cellular telephone operating companies. Through this integration, the field task force receives the occurrences of the ATM network via text messages in their very own communication radios.

The system hereby claimed by the applicant is composed of corporate registers developed to make flexible and to allow for strategic changes in the business rules pertinent to the activation and operational catering. These registers also provide the workflow with the necessary business intelligence so that, in more than 50% of the occurrences, the operators are activated automatically.

For the management of the regional operations and of the outsourced partner companies in the operational catering, it has been made available a Web interface characteristic of the workflow tool (Mid-Tier) for the follow-up and treatment of the occurrences.

Moreover, instructions have been developed, which are sent automatically by the workflow to the ATM application through messaging, with the purpose of remote treatment of the occurrences.

In that way, the results are evident, that is to say, the impact of Innovation which foresees an innovating solution with greater flexibility, and which allows for the attainment of the highest availability indexes of the market.

Besides that, the operational impact which is achieved through the system for the operational activation of banking ATM networks and the method for the management of banking ATM equipment network reduces the volume of manually processed occurrences in around 55% and still promotes the decrease of 90% in the length of time elapsed between the detection of the failure and the deployment of the maintenance teams.

Another aspect of substantial importance regards the monitoring team, which foresees greater availability to cater to the field task force, the latter being provided with more ample resources to plan the route of catering.

### BRIEF DESCRIPTION OF THE DRAWINGS

Complementing the present description—in ways of achieving a better understanding of the characteristics of the utility model, and in accordance with a preferred practical realization of it—a set of drawings, attached hereto, accompanies the description where, in an exemplified—though not limiting—fashion, the following has been represented:

Picture 1 shows a schematic of the method for the management of the banking ATM equipment networks;

FIG. 2 shows a schematic of the system for the operational activation of banking ATM networks.

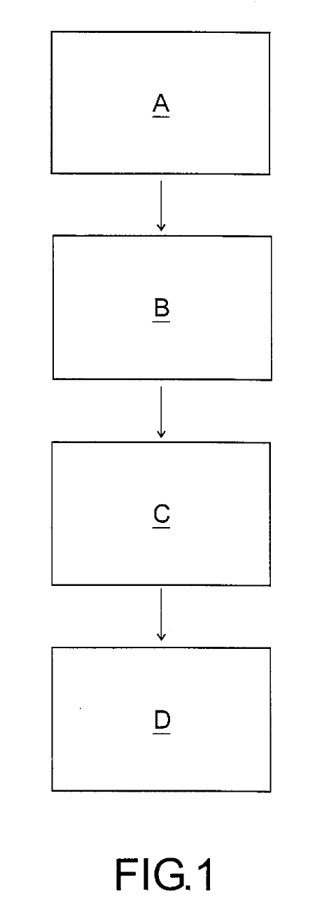

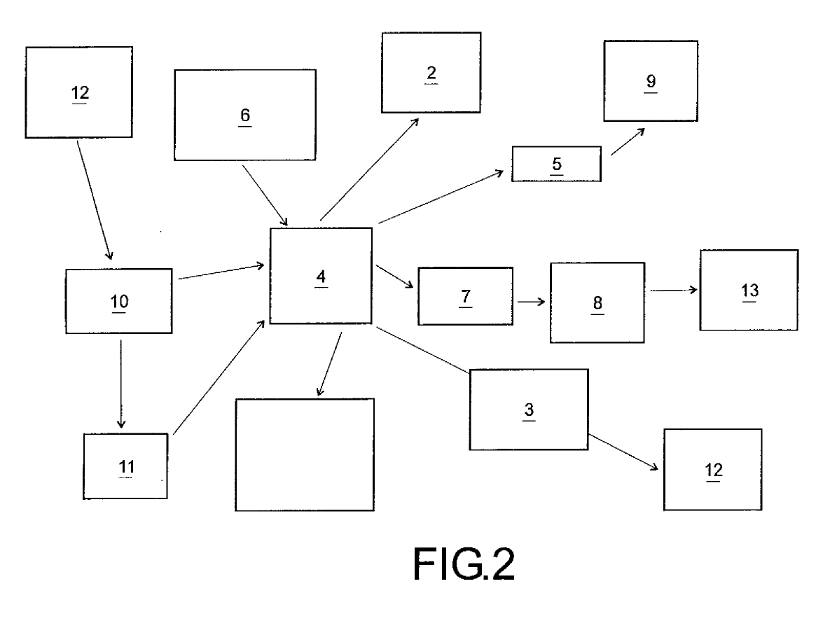

### DETAILED DESCRIPTION OF THE INVENTION

By the fact of intimately knowing the existing difficulties in the mentioned area, and interested in providing the existing systems with improvements, the applicant of the present claim, aiming at developing the management market, implements a new “SYSTEM FOR THE OPERATIONAL ACTIVATION OF BANKING ATM NETWORKS AND METHOD FOR THE MANAGEMENT OF BANKING ATM EQUIPMENT NETWORK”, which more specifically regards a system 1 which foresees a monitoring environment 2, quite efficient for managing networks, with greater expeditiousness in the response to the service orders, and which enables the company, besides that, to optimize the deployment of the field task force in the solicitations for technical assistance to the ATM terminals 12 and elevate the productivity of the team.

This set of procedures and steps to be fulfilled is liable of providing a centralized management of information 10, which ensures a better control and management of the networks, management of the operational processes 11 (activation, operational and technical catering), intelligent activation (business rules defined by the system), optimization of the action of the monitoring technical assistants by automating some if the steps of the process, reduction in the volume of interventions from the field task force, increase in the number of remote actions 3, consolidation of the pieces of information in a single system; friendly interface; greater flexibility in the creation and adaptation of the processes of work; facilitating the integration of the systems which support the operational management.

All of the procedures which involve this context have been developed using BMC Remedy's ARS (Action Request System) workflow tool 4, integrated with a marketed mobile communication solution 5, which is compatible with the main cellular telephone operating companies 13 (suppliers). Through this integration, the field task force receives the occurrences of the ATM network via text messages in their very own communication radios.

Besides that, this system 1 is also composed of corporate registers 6 developed to make flexible and allow for strategic changes in the business rules pertinent to the activation and operational catering. These registers 6 also provide the workflow 4 with the necessary business intelligence so that, in more than 50% of the occurrences, the operators are activated automatically.

For the management of the regional operations and the outsourced partner companies in the operational catering, it has been made available a Web interface 7, characteristic of the workflow tool (Mid-tier) for the follow-up and treatment of the occurrences.

Moreover, instructions have been developed, which are sent automatically by the workflow 8 to the ATM application 12, through messaging, with the purpose of remote treatment of the occurrences. To that end, it has been used the methodology for the Management of Projects: PMI/PMBoK; the process of software development: RUP; and the chosen documenting tool has been Word. In a way that all of these benefits are attained, and the final expected objective is achieved, a differential structure has been developed based on four phases of procedures, such as described in below:

Phase 1 (A)—Asto's availability control;

Phase 2 (B)—Optimization of the activation;

Phase 3 (C)—Implementation of the chain of activation and Implementation of the remote actions; and

Phase 4 (D)—Automating of the activation and of the remote actions.

In the phase 1 (A) (AsTO's 9 availability control) View by the AsTOs 9 activator, proactivity of the activator, record of the balancing of calls:

5. Onboard Diary—Better visualization of the history field;

6. Catering Profile—Greater certainty in the activation: profile of the call x operator;

7. Summer Time and World Time—Greater ease for the activator, improvement ion the communication between the activator and the operator;

8. Closed Premises—activation of calls in accordance with the type of catering, activation of calls only with the premises open;

9. Night activation—Indication of calls which have been originated in situations that took place in the early morning, activation of point enforcement, automatic indication for the activator pertinent to the need of performing a follow-up with the point enforcement company;

10. Control of the length of time for treatment of the calls—Time of displacement, time of operational catering, catering forecast;

11. Technical assistance—Indicators of technical calls: time of duration. Time of part delivery, parts replaced, quantity of technical calls;

12. View of the Monitoring 2 waiting line—Immediate adequation of the monitoring to the needs of operations, decrease in the waiting line to speak with monitoring 2, Reports with productivity indicators of the activators;

Phase 3 Implementation of chain of activation/Implementation of remote actions 3:1. Chain of activation (including via radio/mobile phone, and e-mail)—Ease and expeditiousness in the execution of the chain of activation, generation of reports on the performed chains of activation;

3. Windows remote actions (probe, counting test, and reset by sw)—Increase in the number of calls treated remotely and decrease in the solving time of the calls.

4. Reports—Indicators of activation, treatment and catering of the calls:

Phase 4 Automation of activation and remote actions:

1. Automation of remote action—Expeditiousness in the realization of the remote action, increasing the productivity of the activator, swiftness in the treatment of calls;

2. Automatic activation—Increase in the productivity of the activator, Reduction in the time of activation.

In this way, the results are evident, that is to say: the impact of Innovation which foresees an innovating solution, with flexibility and which allows for the attainment of the highest availability indexes of the market.

Besides that, the operational impact that is obtained through the system for the operational activation of banking ATM networks and the method for the management of banking ATM equipment networks reduces the volume of manually processed calls in around 55% and promotes, moreover, a decrease of 90% in the length of time elapsed between the detection of the failure and the deployment of the maintenance teams.

The strategy of dividing the project in phases has rendered more immediate benefits to the client and enabled the maturation of the process drawn for the definitions in the phases that followed.

Whilst the preferred realization of the present Invention is described, whatsoever modifications and/or alterations must be understood as within and scope of the Invention, perfectly accommodating within the criteria which define the invention, that is to say, to cover itself with novelty, inventive activity, and industrial application.

1. A “SYSTEM FOR THE OPERATIONAL ACTIVATION OF BANKING ATM NETWORKS”, which foresees a quite efficient monitoring environment for managing networks with greater expeditiousness in the response to the service orders and which, besides that, allows for the company to optimize the activation of the field task force in the solicitation of technical assistance for the terminals and to elevate the productivity of the team, wherein it presents, in phase 1 [AsTO's (9) availability control], a View of PA—decrease in the time of displacement; Automatic login, logout, and pausing—Issuing of indicators of hours worked by the AsTOs (9) for facilitating the management of the Consultants, Reduction in the length of time of login, Reduction in the renegotiation of calls; AsTO's (9) work schedule in the ARS (4)—productivity increase of the Activators, Centralization of the functionalities in the ARS (4) for the utilization of the Consultant and of the Monitoring (2); Availability of WEB (7) for the third parties—Reduction in the length of activation time of third parties; in the phase 2—optimization of the activation, prioritization of the calls—activation with a focus on the business of the company, on the clients, and on the signed contracts; Relapse of calls—Automatic analysis of relapse of calls, differentiated treatment provided by the Operator to the call; Amount of activations—Optimization of the operational catering, optimization of the human resources; balancing—View by the ASTOS (9) activator, proactivity of the activator, recording of the balancing of calls; Onboard Diary—Better view of the history field; profile of catering—Greater certainty in the activation: profiled of the call x caterer; Summer time and world time—Grater ease for the activator, improvement in the communication between the activator and the operator; Closed Premises—Activation of calls in accordance with the type of catering, activation of calls only with the premises open; night activation—Indication of calls which had been originated in situations which took place during the early morning, activations of point enforcement, automatic indication for the activator pertinent to the need of performing a follow-up with the company of point enforcement; Control of the length of time of the calls—Time of displacement, time of operational catering, catering forecast; technical Assistance—Indicators of technical calls: time of duration, time elapsed for the delivery of the part, parts replaced, amount of technical calls; View of the waiting line of the Monitoring—Immediate adequation of the monitoring to the needs of operations, reduction in the waiting line to speak with monitoring, reports with indicators of productivity of the indicators; in phase 3, occurs the implementation of the chain of activation/Implementation of remote actions, chain of activation (including via radio/mobile phone, and e-mail)—Ease and expeditiousness in the chain of activation, generation of reports on the chains of activation performed; Windows remote actions (probe, counting test, and reset by sw)—Increase in the number of calls treated remotely and decrease in the time of the solution of the calls; Reports—Indicators of activation, treatment, and catering of the calls; and, in phase 4, automation of activation and remote actions (3), Automation of remote action—Expeditiousness in the realization of the remote action (3), in crease in the productivity of the activator, swiftness in the treatment of calls; Automatic activation—Increase in the productivity of the activator, Reduction in the time for activation.

2. A “SYSTEM FOR THE OPERATIONAL ACTIVATION OF BANKING ATM NETWORKS AND METHOD FOR THE MANAGEMENT OF BANKING ATM EQUIPMENT NETWORK”, in accordance with claim 1, wherein it presents a Web interface (7) characteristic of the tool (8) of workflow (4) (Mid-tier) for the management of the regional operations and of the outsourced companies that are partners in the operational catering.

3. A “SYSTEM FOR THE OPERATIONAL ACTIVATION OF BANKING ATM NETWORKS AND METHOD FOR THE MANAGEMENT OF BANKING ATM EQUIPMENT NETWORK”, in accordance with claim 1, wherein the procedures which involve this context are developed using the tool (8) of workflow (4) ARS (Action Request System) of BMC Remedy, integrated with a marketed mobile communication solution compatible with the main cellular telephone operating companies; through that integration, the field task force receives the occurrences of the ATM network via text messages in their very own communication radios.

4. A “SYSTEM FOR THE OPERATIONAL ACTIVATION OF BANKING ATM NETWORKS AND METHOD FOR THE MANAGEMENT OF BANKING ATM EQUIPMENT NETWORK”, in accordance with claim 1, wherein the system foresees corporate registers which provide the workflow (8) with the necessary business intelligence in order that, in more than 50% of the calls, the operators are activated automatically.

5. A “SYSTEM FOR THE OPERATIONAL ACTIVATION OF BANKING ATM NETWORKS AND METHOD FOR THE MANAGEMENT OF BANKING ATM EQUIPMENT NETWORK”, in accordance with claims 1, wherein the instructions are automatically sent by the workflow (8) to the ATM application (12) through messaging, with the purpose of the remote treatment of the occurrences; through three points, which are:
1—of the methodology for the Management of Projects: PMI/PMBoK; 2—of the process of development of software: RUP; and 3—of the chosen documenting tool: Word.

6. A “SYSTEM FOR THE OPERATIONAL ACTIVATION OF BANKING ATM NETWORKS AND METHOD FOR THE MANAGEMENT OF BANKING ATM EQUIPMENT NETWORK”, in accordance with claim 1, wherein it presents a system (1) developed with the tool of “workflow ARS” (8) (Action request System), integrated with a mobile communication solution (5) compatible with the main cellular telephone operating companies; through that integration, the field task force receives the occurrences in the ATM network via text messages in their very own communication radios.

7. A “SYSTEM FOR THE OPERATIONAL ACTIVATION OF BANKING ATM NETWORKS AND METHOD FOR THE MANAGEMENT OF BANKING ATM EQUIPMENT NETWORK”, in accordance with claim 1, wherein it presents a system composed of corporate registers (6) developed to make flexible and allow for strategic changes in the business rules pertinent to the activation and operational catering; these registers also provide the workflow (8) with the necessary business intelligence in order that, in more than 50% of the cases, the operators are activated automatically.

8. A “SYSTEM FOR THE OPERATIONAL ACTIVATION OF BANKING ATM NETWORKS AND METHOD FOR THE MANAGEMENT OF BANKING ATM EQUIPMENT NETWORK”, in accordance with claim 1, wherein it presents a Web interface (7) characteristic of the tool (8) of workflow (4) (Mid-tier) for the follow-up and treatment of the occurrences.

9. A “SYSTEM FOR THE OPERATIONAL ACTIVATION OF BANKING ATM NETWORKS AND METHOD FOR THE MANAGEMENT OF BANKING ATM EQUIPMENT NETWORK”, in accordance with claim 1, wherein it presents instructions, which are sent automatically by the workflow (8) to the ATM application (12) through messaging, with the purpose of the remote treatment of the occurrences.

10. A “METHOD FOR THE MANAGEMENT OF BANKING ATM EQUIPMENT NETWORK”, in accordance with claim 1, wherein it presents a differential structure based on 4 phases of procedures such as described ahead: Phase 1 (A)—AsTO's (9) availability control; Phase 2 (B)—Optimization of the activation; Phase 3 (C)—Implementation of the chain of activation and Implementation of the remote actions (3); and phase 4 (D)—Automation of the activation and of the remote actions (3).
